(19) United States
(12) Patent Application Publication
(10) Pub. No.: US 2024/0046386 A1
(43) Pub. Date: Feb. 8, 2024

(54) PREQUALIFICATION OF USERS

(71) Applicant: Rello Group Inc., New York, NY (US)

(72) Inventors: Ran Ben Yair, Brooklyn, NY (US); Gilad Amitai, Brooklyn, NY (US); Adam Semler, Chappaqua, NY (US); Alex Friedman, Brooklyn, NY (US)

(21) Appl. No.: 18/230,122

(22) Filed: Aug. 3, 2023

Related U.S. Application Data
(60) Provisional application No. 63/370,539, filed on Aug. 5, 2022.

(51) Int. Cl. G06Q 50/16; G06Q 40/03

(52) U.S. Cl. CPC G06Q 50/16; G06Q 40/03

(57) ABSTRACT

A method includes identifying property data associated with a plurality of properties. The method further includes identifying user data associated with one or more users. The method further includes determining, based on the property data and the user data, that the one or more users are prequalified for a subset of the plurality of properties. The method further includes causing a graphical representation of the subset of the plurality of properties to be displayed via a user device to the one or more users.

### RELATED APPLICATION

This application claims benefit of Provisional Application No. 63/370,539, filed Aug. 5, 2022, the entire content of which is incorporated by reference herein.

### TECHNICAL FIELD

Embodiments of the present disclosure relate to prequalification, and in particular to prequalification of users.

### BACKGROUND

Agreements are made between users for use of a good, service, or property owned by another. For example, a user may enter into a rental agreement to rent a property owned by another over a fixed period of time.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1A-B are block diagrams illustrating exemplary system architectures, according to certain embodiments.

FIG. 2 illustrates a data set generator, according to certain embodiments.

FIG. 3 is a block diagram illustrating a system for generating predictive data, according to certain embodiments.

FIGS. 4A-E illustrate flow diagrams of methods associated with prequalification of users, according to certain embodiments.

FIGS. 5A-B are block diagrams illustrating computer systems, according to certain embodiments.

### DETAILED DESCRIPTION OF EMBODIMENTS

Embodiments described herein are related to prequalification of users (e.g., dynamic access analysis verification and prepopulated authentication). For example, a system can one or more of dynamically analyze retrieved data for verification and prepopulated authentication, access financial data to dynamically preapprove one or applicants for leasing, dynamically value, via a computer vision algorithm, one or more properties, use artificial intelligence and machine learning to categorize transaction types, or access financial data to automatically value one or more applicants.

Agreements may be made between users for use of a good, service, or property owned by another. For example, a user may enter into a rental agreement to rent a property owned by another over a fixed period of time. The property may include housing (e.g., house, apartment, condo, townhome, room, etc.).

Conventionally, renting a property (e.g., renting an apartment) is a painful process full of stress and anxiety for the user (e.g., renter). It does not matter if you are a student with no credit, an immigrant, or someone who does have credit, applying to rent a property (e.g., an apartment) has a lot of demands. Renters have very little (e.g., zero) visibility and do not know how their application compares against others. Finding an apartment can take days, if not weeks. If the renter does not get an apartment, the renter may never be informed why.

Many other aspects of modern-day life is quick and seamless. Users can go online, click a button, pay, and order many different types of goods and services. However, the leasing or renting of properties (e.g., apartments) still centers around the application process which can cause the renter a lot of stress and anxiety. This current process or system is broken. Potential renters have to share sensitive information over email to people the potential renter may have never met.

Conventionally, verification of the potential renter is a time-consuming manual process, and since renters are applying to multiple apartments, owners do not know if an accepted renter will sign the lease, causing friction in the leasing process.

Conventionally, application data is easy to fake, and most applications rely on credit score, which may be an incomplete and archaic way to figure out if a potential renter is a good renter or not. Additionally, conventionally, every time an owner rents an apartment, the owner has to pay a broker adding significant costs to the leasing process.

The devices, systems, and methods disclosed herein provide prequalification of users (e.g., dynamic access analysis verification and prepopulated authentication).

In some embodiments, a processing device identifies property data associated with properties. The property data may include one or more of property location data, property size data, property amenity data, property building type data, and/or property image data captured by an imaging device. The properties may be available to enter into an agreement (e.g., rental agreement, lease agreement, purchase agreement, etc.). The properties may include one or more of an apartment, a condo, a townhome, a house, a building, one or more rooms, a basement, an office, and/or the like.

The processing device further identifies user data associated with one or more users. The user data may include one or more of financial data, employer data, historical rental data, current rental data, and/or payment history data. The one or more users may include a user (e.g., renter, leaser, buyer), a group of users (e.g., that are going to enter into the agreement together, roommates, family, couple, etc.), and/or a user and a guarantor (e.g., someone that is going to guarantee at least a portion of the rent amount).

The processing device further determines, based on the property data and the user data, that the one or more users are prequalified for a subset of the properties. In some embodiments, the processing device determines a renter score for the one or more users, determines a threshold renter score for each of the properties, and determines that the renter score meets the threshold renter score for the subset of the properties. The subset of the properties may be properties for which the one or more users are prequalified.

The processing device further causes a graphical representation of the subset of the properties to be displayed via a user device to the one or more users. In some embodiments, responsive to user input via the user device to select a first property of the subset, the one or more users may enter into a rental agreement for the first property (e.g., without sending a rental application, cause the processing device to prepopulate the rental application, etc.). In some embodiments, responsive to user input via the user device to select a first property of the subset, the one or more users may bid on the first property. Responsive to a threshold amount of time passing or the bid matching meeting a threshold rental amount, the one or more users may enter into a rental agreement for the first property.

In some embodiments the present disclosure provides a solution to shortcomings of conventional solutions (e.g., removes or lessens pain points from process of leasing, renting, buying, etc.) by removing applications from the process. Removing the application can create opportunities for the potential renter and the owner.

In some embodiments, the present disclosure prequalifies one or more users (e.g., potential renters, potential leasers, potential buyers, etc. for properties such as apartments) by eliminating the application process. In some embodiments, the present disclosure shows the user (e.g., renter, leaser, buyer) apartments the renter prequalifies for, eliminating the need to apply for multiple apartments, and eliminating time wasted by the owner in reviewing unqualified potential renters. The prequalification data can be based on the potential renter's financial data. This financial data can be retrieved form a potential renter's employer or bank accounts via a banking application programming interface (API) such as Plaid. By leveraging open banking and FinTech infrastructure the system can prequalify potential renters in real time. The banking information can show if a potential renter pays bills or rent on time and can provide the system with multiple years of context.

Traditionally, a credit score must be tied to a specific application so when the potential renter applies for a specific apartment, the credit score gets checked, therefore, prequalification is not possible with credit scores. In some embodiments, the present disclosure is not tied to a specific application.

The systems, devices, and methods disclosed herein have advantages over conventional solutions. In some embodiments, the present disclosure causes display of properties for which users are prequalified compared to conventional systems where different application forms are filled out and transmitted, received, and processed by administrators, and denials and acceptances are transmitted by the administrators to users. The present disclosure uses much less processor overhead, energy consumption, and bandwidth compared to conventional solutions. The present disclosure reduces the stress and anxiety for the user and may have less demands than conventional systems. The present disclosure reduces or eliminates the transmission of sensitive information by users to administrators (e.g., property owners, property managers, etc.). The present disclosure uses less time and reduces (or eliminates) manual operations of entering into rental agreements compared to conventional solutions. The present disclosure may make more accurate decisions (e.g., use information that is more complete, less archaic, and/or less fake) compared to conventional systems.

Although some embodiments of the present disclosure refer to renters and rental apartments, in some embodiments, the present disclosure can be applied to one or more users (e.g., a user, a group of users, a user and a guarantor, etc.) entering into an agreement (e.g., rental agreement, leasing agreement, purchase agreement, etc.) for one or more different types of properties (e.g., apartment, condo, townhome, house, building, one or more rooms, etc.).

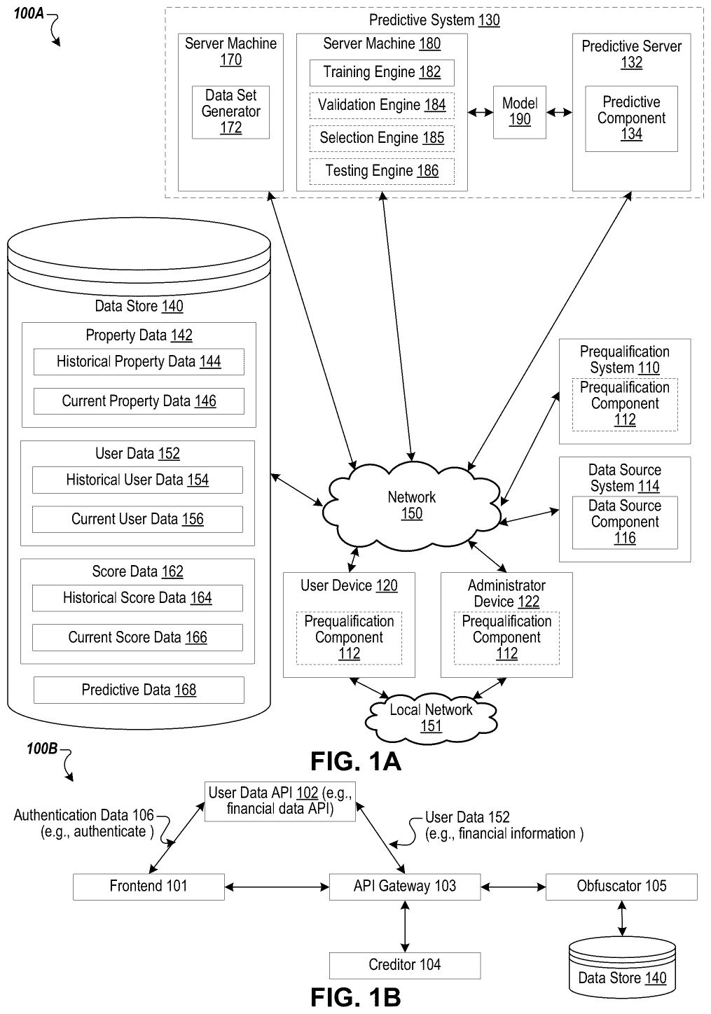

FIG. 1A-B are block diagrams illustrating systems 100A-B (e.g., exemplary system architectures), according to certain embodiments.

FIG. 1A is a block diagram illustrating an exemplary system 100A (exemplary system architecture), according to certain embodiments. The system 100A includes prequalification system 110, data source system 114, one or more user devices 120, one or more administrative devices 122, predictive server 132, and data store 140. In some embodiments, predictive server 132 is part of predictive system 130. In some embodiments, predictive system 130 further includes server machines 170 and 180.

In some embodiments, one or more of prequalification system 110, data source system 114, one or more user devices 120, one or more administrative devices 122, predictive server 132, and/or data store 140 are coupled to each other via a network 150. In some embodiments, network 150 is a public network that provides user device 120 with access to prequalification system 110, data source system 114, one or more user devices 120, one or more administrative devices 122, predictive server 132, data store 140, and other publicly available computing devices. In some embodiments, network 150 is a private network that provides user device 120 with access to prequalification system 110, data source system 114, one or more user devices 120, one or more administrative devices 122, predictive server 132, data store 140, and other privately available computing devices. In some embodiments, network 150 includes one or more Wide Area Networks (WANs), Local Area Networks (LANs), wired networks (e.g., Ethernet network), wireless networks (e.g., an 802.11 network or a Wi-Fi® network), cellular networks (e.g., a Long Term Evolution (LTE) network), radar units, transmission antenna, reception antenna, microwave transmitter, microwave receiver, sonar devices, Lidar devices, routers, hubs, switches, server computers, cloud computing networks, and/or a combination thereof.

In some embodiments, one or more user devices 120 and/or administrator devices 122 communicate over network 150. In some embodiments, one or more user devices 120 and/or administrator devices 122 communicate over a local network 151. Local network 151 may be a computing network that provides one or more communication channels between user devices 120 and/or administrator devices 122. In some examples, local network 151 is a peer-to-peer network that does not rely on a pre-existing network infrastructure (e.g., access points, switches, routers) and user devices 120 and/or administrator devices 122 replace the networking infrastructure to route communications between the user devices 120 and/or administrator devices 122. Local network 151 may be a wireless network that is self-configuring and enables user devices 120 and/or administrator devices 122 to contribute to local network 151 and dynamically connect and disconnect from local network 151 (e.g., ad hoc wireless network). In some examples, local network 151 is a computing network that includes networking infrastructure that enables user devices 120 and/or administrator devices 122 to communicate with other user devices 120 and/or administrator devices 122. The local network 151 may or may not have access to the public network (e.g., internet, network 150). For example, an access point or device that may function as an access point to enable user devices 120 and/or administrator devices 122 to communicate with one another without providing internet access. In some embodiments, the local network 151 provides access to a larger network such as network 150 (e.g., Internet). In some embodiments, local network 151 is based on any wireless or wired communication technology. The wireless communication technology may include Bluetooth®, Wi-Fi®, infrared, ultrasonic, or other technology. The wired communication may include universal serial bus (USB), Ethernet, RS 232, or other wired connection. The local network 151 may be an individual connection between two user devices 120 and/or administrator devices 122 or may include multiple connections.

In some embodiments, the user device 120 and/or administrator device 122 includes a computing device such as Personal Computers (PCs), laptops, mobile phones, smart phones, tablet computers, netbook computers, gateway device, etc. In some embodiments, the user device 120 and/or administrative device 122 includes a prequalification component 112. User device 120 and/or administrative device 122 includes an operating system that allows users to one or more of generate, view, or edit data.

In some embodiments, prequalification component 112 identifies property data 142 (e.g., from administrator device 122, from data source system 114, from data store 140), identifies user data 152 (e.g., from user device 120, from data source system 114, from data store 140), determines that a user is prequalified for (e.g., prequalified to rent, lease, purchase, etc.) one or more properties, and causes a graphical representation of the one or more properties to be displayed via a user device 120 to the user. The prequalification component 112 may receive the property data 142 and/or user data 152 via user input (e.g., via a Graphical User Interface (GUI) displayed via the user device 120 or administrator device 122). In some embodiments, the prequalification component 112 transmits the property data 142 and/or user data 152 to the predictive system 130, receives output (e.g., predictive data 160 determined via one or more trained machine learning models 190) from the predictive system 130, determines that a user is prequalified for (e.g., prequalified to rent, lease, purchase, etc.) one or more properties, and causes a graphical representation of the one or more properties to be displayed via a user device 120 to the user. In some embodiments, the prequalification component 112 provides and/or obtains data from data store 140 and the predictive server 132 provides and/or obtains data from data store 140 (e.g., data store 140 is the intermediary between prequalification component 112 and predictive server 132).

In some embodiments, the predictive server 132, server machine 170, and server machine 180 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

In some embodiments, the predictive system 130 (e.g., predictive server 132, predictive component 134) generates predictive data 160 using supervised machine learning (e.g., supervised data set, labeled data, etc.). In some embodiments, the predictive system 130 generates predictive data 160 using semi-supervised learning (e.g., semi-supervised data set, a predictive percentage, etc.). In some embodiments, the predictive system 130 generates predictive data 160 using unsupervised machine learning (e.g., unsupervised data set, clustering, etc.).

In some embodiments, the data store 140 is memory (e.g., random access memory), a drive (e.g., a hard drive, a flash drive), a database system, or another type of component or device capable of storing data. In some embodiments, data store 140 includes multiple storage components (e.g., multiple drives or multiple databases) that span multiple computing devices (e.g., multiple server computers). In some embodiments, the data store 140 stores one or more of property data 142, user data 152, score data 162, and/or predictive data 160.

Property data 142 includes historical property data 144 and current property data 146. In some embodiments, property data 142 includes one or more of property location data, property size data, property amenity data, property building type data, and/or property image data captured by an imaging device.

User data 152 includes historical user data 154 and current user data 156. In some embodiments, user data 152 includes one or more of financial data, employer data, historical rental data, current rental data, and/or payment history data.

Score data 162 includes historical score data 164 and current score data 166. In some embodiments, score data 162 includes one or more of a renter score, a threshold renter score, prequalification score, score for a user, score for a guarantor, score for combination of user and guarantor, etc.

In some embodiments, predictive data 168 is associated with a predicted score (e.g., prediction of current score data 166).

Historical data includes one or more of historical property data 144, historical user data 154, and/or historical score data 164 (e.g., at least a portion for training the machine learning model 190). Current data includes one or more of current property data 146, current user data 156, and/or current score data 166 (e.g., at least a portion to be input into the trained machine learning model 190 subsequent to training the model 190 using the historical data) for which predictive data 160 is generated. In some embodiments, the current data is used for retaining the trained machine learning model 190.

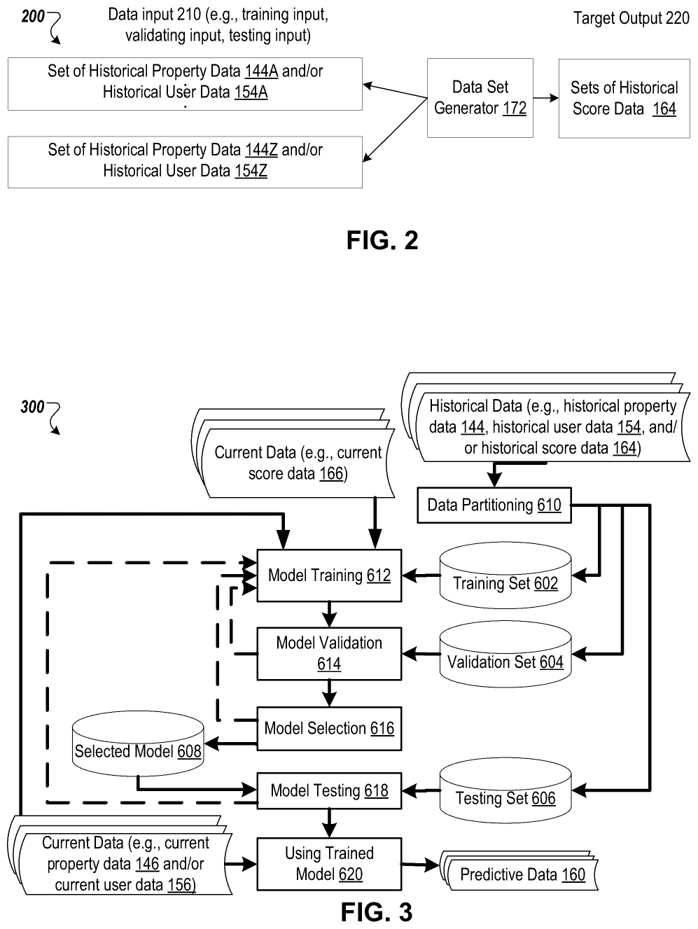

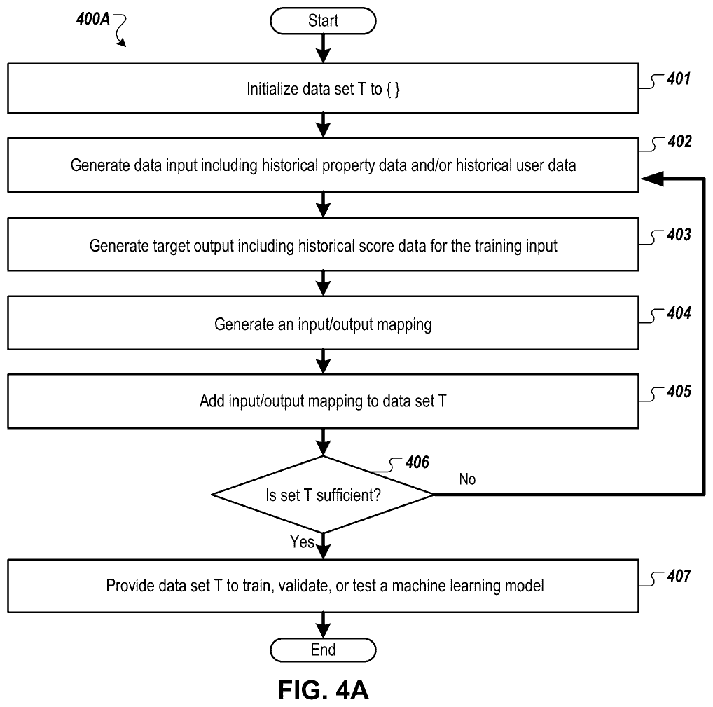

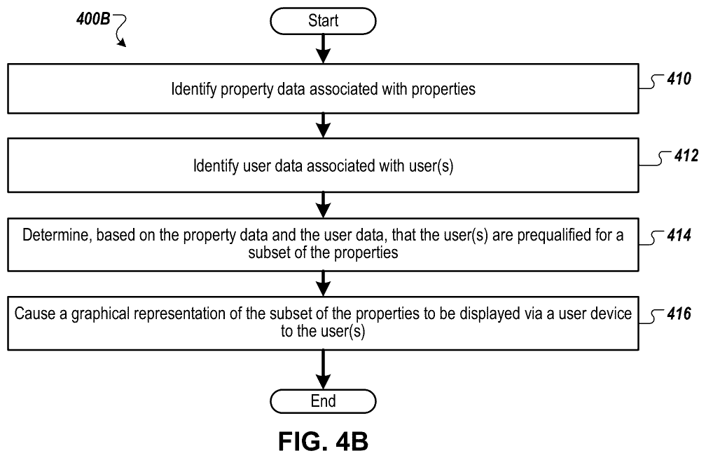

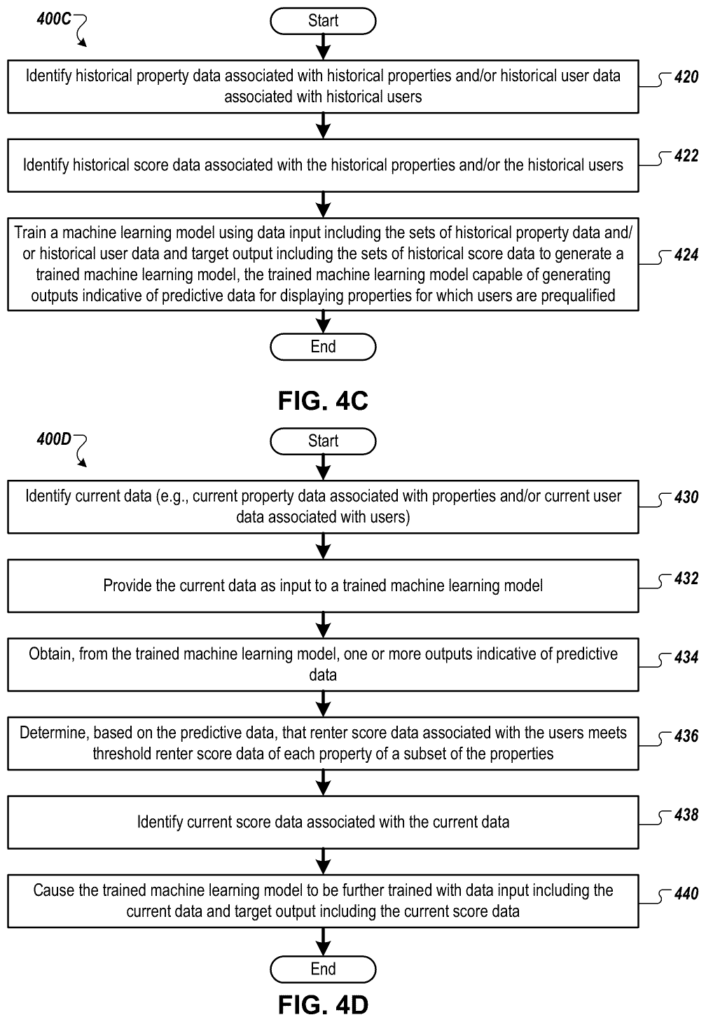

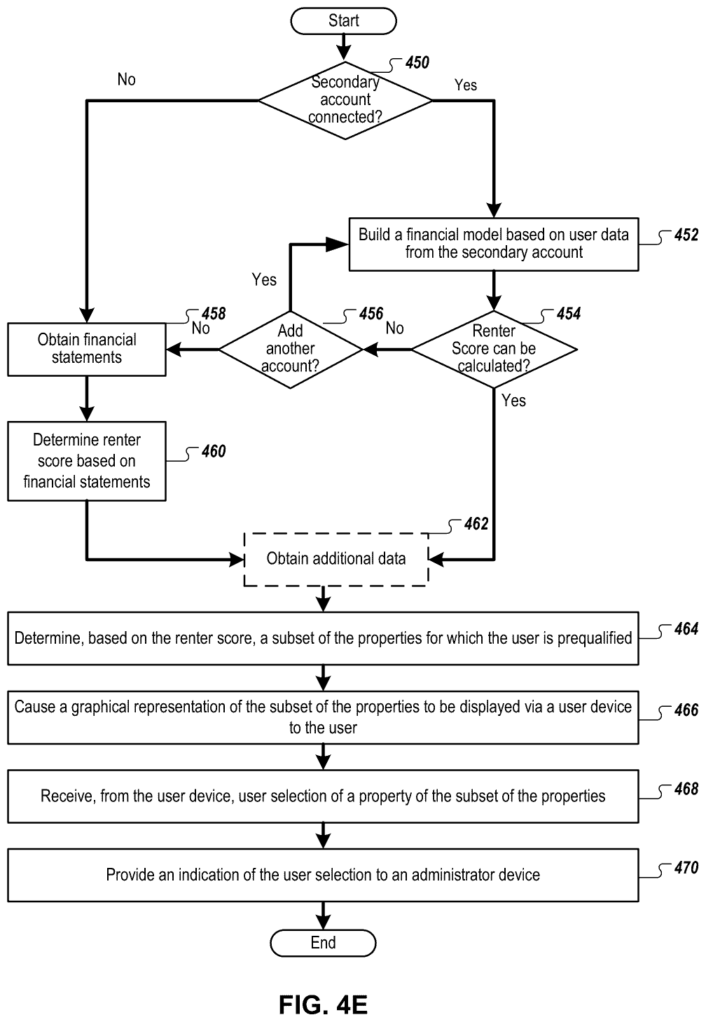

In some embodiments, predictive system 130 further includes server machine 170 and server machine 180. Server machine 170 includes a data set generator 172 that is capable of generating data sets (e.g., a set of data inputs and a set of target outputs) to train, validate, and/or test a machine learning model(s) 190. Some operations of data set generator 172 are described in detail below with respect to FIGS. 2 and 4A. In some embodiments, the data set generator 172 partitions the historical data (e.g., historical property data 144, historical user data 154, and/or historical score data 164) into a training set (e.g., sixty percent of the historical data), a validating set (e.g., twenty percent of the historical data), and a testing set (e.g., twenty percent of the historical data). In some embodiments, the predictive system 130 (e.g., via predictive component 134) generates multiple sets of features. In some examples, a first set of features corresponds to a first set of types of sensor data (e.g., from a first set of sensors, first combination of values from first set of sensors, first patterns in the values from the first set of sensors) that correspond to each of the data sets (e.g., training set, validation set, and testing set) and a second set of features correspond to a second set of types of sensor data (e.g., from a second set of sensors different from the first set of sensors, second combination of values different from the first combination, second patterns different from the first patterns) that correspond to each of the data sets.

Server machine 180 includes a training engine 182, a validation engine 184, selection engine 185, and/or a testing engine 186. In some embodiments, an engine (e.g., training engine 182, a validation engine 184, selection engine 185, and a testing engine 186) refers to hardware (e.g., circuitry, dedicated logic, programmable logic, microcode, processing device, etc.), software (such as instructions run on a processing device, a general-purpose computer system, or a dedicated machine), firmware, microcode, or a combination thereof. The training engine 182 is capable of training a machine learning model 190 using one or more sets of features associated with the training set from data set generator 172. In some embodiments, the training engine 182 generates multiple trained machine learning models 190, where each trained machine learning model 190 corresponds to a distinct set of features of the training set (e.g., sensor data from a distinct set of sensors). In some examples, a first trained machine learning model was trained using all features (e.g., X1-X5), a second trained machine learning model was trained using a first subset of the features (e.g., X1, X2, X4), and a third trained machine learning model was trained using a second subset of the features (e.g., X1, X3, X4, and X5) that partially overlaps the first subset of features.

The validation engine 184 is capable of validating a trained machine learning model 190 using a corresponding set of features of the validation set from data set generator 172. For example, a first trained machine learning model 190 that was trained using a first set of features of the training set is validated using the first set of features of the validation set. The validation engine 184 determines an accuracy of each of the trained machine learning models 190 based on the corresponding sets of features of the validation set. The validation engine 184 discards trained machine learning models 190 that have an accuracy that does not meet a threshold accuracy. In some embodiments, the selection engine 185 is capable of selecting one or more trained machine learning models 190 that have an accuracy that meets a threshold accuracy. In some embodiments, the selection engine 185 is capable of selecting the trained machine learning model 190 that has the highest accuracy of the trained machine learning models 190.

The testing engine 186 is capable of testing a trained machine learning model 190 using a corresponding set of features of a testing set from data set generator 172. For example, a first trained machine learning model 190 that was trained using a first set of features of the training set is tested using the first set of features of the testing set. The testing engine 186 determines a trained machine learning model 190 that has the highest accuracy of all of the trained machine learning models based on the testing sets.

In some embodiments, the machine learning model 190 refers to the model artifact that is created by the training engine 182 using a training set that includes data inputs and corresponding target outputs (correct answers for respective training inputs). Patterns in the data sets can be found that map the data input to the target output (the correct answer), and the machine learning model 190 is provided mappings that captures these patterns. In some embodiments, the machine learning model 190 uses one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network), etc. In some embodiments, the machine learning model 190 is a multi-variable analysis (MVA) model.

Predictive component 134 provides current property data 146 and/or current user data 156 to the trained machine learning model 190 and runs the trained machine learning model 190 on the input to obtain one or more outputs. The predictive component 134 is capable of determining (e.g., extracting) predictive data 160 from the output of the trained machine learning model 190 and determines (e.g., extracts) confidence data from the output that indicates a level of confidence that the predictive data 160 corresponds to current score data 162 at the current property data 146 and/or current user data 156. In some embodiments, the predictive component 134 or prequalification component 112 use the confidence data to decide whether to cause display of particular properties based on the predictive data 160.

The confidence data includes or indicates a level of confidence that the predictive data 160 corresponds to current score data 166 at the current property data 146 and/or current user data 156. In some examples, the level of confidence is a real number between 0 and 1 inclusive, where 0 indicates no confidence that the predictive data 160 corresponds to current score data 166 associated with the current property data 146 and/or current user data 156 and 1 indicates absolute confidence that the predictive data 160 corresponds to current score data 166 associated with the current property data 146 and/or current user data 156. Responsive to the confidence data indicating a level of confidence below a threshold level for a predetermined number of instances (e.g., percentage of instances, frequency of instances, total number of instances, etc.) the predictive component 134 causes the trained machine learning model 190 to be re-trained (e.g., based on the current property data 146, current user data 156, current score data 166, and/or the like).

For purpose of illustration, rather than limitation, aspects of the disclosure describe the training of one or more machine learning models 190 using historical data (e.g., historical property data 144, historical user data 154, and/or historical score data 164) and inputting current data (e.g., current property data 146 and/or current user data 156) into the one or more trained machine learning models 190 to determine predictive data 160 (e.g., predicting current score data 166). In other implementations, a heuristic model or rule-based model is used to determine predictive data 160 (e.g., without using a trained machine learning model). Predictive component 134 monitors historical property data 144, historical user data 154, and/or historical score data 164. In some embodiments, any of the information described with respect to data inputs 210 of FIG. 2 are monitored or otherwise used in the heuristic or rule-based model.

In some embodiments, the functions of user device 120, administrator device 122, prequalification system 110, data source system 114, predictive server 132, server machine 170, and/or server machine 180 are be provided by a fewer number of machines. For example, in some embodiments, server machines 170 and 180 are integrated into a single machine, while in some other embodiments, server machine 170, server machine 180, and predictive server 132 are integrated into a single machine. In some embodiments, user device 120 and predictive server 132 are integrated into a single machine.

In general, functions described in one embodiment as being performed by user device 120, administrator device 122, prequalification system 110, data source system 114, predictive server 132, server machine 170, and server machine 180 can also be performed on predictive server 132 in other embodiments, if appropriate. In addition, the functionality attributed to a particular component can be performed by different or multiple components operating together. For example, in some embodiments, the predictive server 132 which properties to display (e.g., for which properties the user is prequalified) based on the predictive data 160. In another example, user device 120 determines the predictive data 160 based on output from the trained machine learning model.

In some embodiments, the prequalification component 112 is part of the predictive system 130 (e.g., predictive server 132). In some embodiments, the predictive component 134 is part of the user device 120, administrator device 122, prequalification system 110, and/or data source system 114.

In addition, the functions of a particular component can be performed by different or multiple components operating together. In some embodiments, one or more of the predictive server 132, server machine 170, or server machine 180 are accessed as a service provided to other systems or devices through appropriate application programming interfaces (API).

In some embodiments, a “user” is represented as a single individual. However, other embodiments of the disclosure encompass a “user” being an entity controlled by a plurality of users (e.g., group of users, user and a guarantor, etc.) and/or an automated source. In some examples, a set of individual users federated as a group of administrators is considered a “user.”

Although embodiments of the disclosure are discussed in terms of generating predictive data 160 to determine for which properties a user is prequalified, in some embodiments, the disclosure can also be generally applied to verification (e.g., dynamic access analysis verification) and/or authentication (e.g., prepopulated authentication). Embodiments can be generally applied to prequalifying (e.g., without manually filling out a particular application for a particular property).

FIG. 1B displays a system 100B that is used to handle user data 152 for prequalification of users, according to certain embodiments.

System 100B includes a frontend 101, a user data API 102, an API gateway 103, a creditor 104, an obfuscator 105, and/or a data store 140.

Frontend 101 (e.g., user device 120, administrator device 122, prequalification system 110, data source system 114, etc.) may be used to authenticate a request for user data 152. In some embodiments, authentication data 106 is transmitted between frontend 101 and user data API 102 to authenticate a request for user data 152.

User data API 102 may be a financial information API, such as Plaid. User data 152 (e.g., financial information) may be transmitted between user data API 102 and API gateway 103.

API gateway 103 may accept and process API calls. Creditor 104 may provide and/or request user data 152. Obfuscator 105 may remove sensitive information from user data 152 prior to storing user data 152 in data store 140 and/or after receiving user data 152 from data store 140. Data store 140 may store the user data 152.

In some embodiments, frontend 101 authenticates a connection with user data API 102 by transmitting authentication data 106. The frontend 101 may then transmit a request for user data 152 to user data API 102 and/or API gateway 103. The user data API 102 may transmit the request to API gateway 103. The API gateway 103 may obtain the user data 152 from creditor 104 and/or data store 140 via obfuscator 105 (e.g., to remove sensitive information). The API gateway 103 may transmit user data 152 via obfuscator 105 (e.g., to remove sensitive information) to data store 140). User data 152 may be transmitted from API gateway 103 to the user data API 102 and from there to frontend 101.

FIG. 2 illustrates data set generator 172 (e.g., data set generator 172 of FIG. 1A) to create data sets for a machine learning model (e.g., model 190 of FIG. 1A), according to certain embodiments. In some embodiments, data set generator 172 is part of server machine 170 of FIG. 1A.

Data set generator 172 creates data sets for a machine learning model (e.g., model 190 of FIG. 1A). Data set generator 172 creates data sets using historical property data 144, historical user data 154, and/or historical score data 164. System 200 of FIG. 2 shows data set generator 172, data inputs 210, and target output 220.

In some embodiments, data set generator 172 generates a data set (e.g., training set, validating set, testing set) that includes one or more data inputs 210 (e.g., training input, validating input, testing input) and one or more target outputs 220 that correspond to the data inputs 210. The data set also includes mapping data that maps the data inputs 210 to the target outputs 220. Data inputs 210 are also referred to as “features,” “attributes,” or “information.” In some embodiments, data set generator 172 provides the data set to the training engine 182, validating engine 184, or testing engine 186, where the data set is used to train, validate, or test the machine learning model 190. Some embodiments of generating a training set are further described with respect to FIG. 4A.

In some embodiments, data set generator 172 generates the data input 210 and target output 220. In some embodiments, data inputs 210 include one or more sets of historical property data 144 and/or historical user data 154. Each instance of historical property data 144 and/or historical user data 154 includes one or more of types of data, combination of data, patterns from data, etc.

In some embodiments, data set generator 172 generates a first data input corresponding to a first set of historical property data 144A and/or historical user data 154A to train, validate, or test a first machine learning model and the data set generator 172 generates a second data input corresponding to a second set of historical property data 144B and/or historical user data 154B to train, validate, or test a second machine learning model.

In some embodiments, the data set generator 172 discretizes (e.g., segments) one or more of the data input 210 or the target output 220 (e.g., to use in classification algorithms for regression problems). Discretization (e.g., segmentation via a sliding window) of the data input 210 or target output 220 transforms continuous values of variables into discrete values. In some embodiments, the discrete values for the data input 210 indicate discrete historical property data 144 and/or historical user data 154 to obtain a target output 220 (e.g., discrete score data).

Data inputs 210 and target outputs 220 to train, validate, or test a machine learning model include information for a particular location (e.g., region, city, type of property, etc.).

In some embodiments, the information used to train the machine learning model is from specific types and/or groups of properties having specific characteristics (e.g., same or similar type of property, etc.) and allow the trained machine learning model to determine outcomes for same or similar types of properties having same or similar specific characteristics based on current property data 146.

In some embodiments, subsequent to generating a data set and training, validating, or testing a machine learning model 190 using the data set, the machine learning model 190 is further trained, validated, or tested (e.g., current score data 166 of FIG. 1A) or adjusted (e.g., adjusting weights associated with input data of the machine learning model 190, such as connection weights in a neural network).

FIG. 3 is a block diagram illustrating a system 300 (e.g., predictive system 130 of FIG. 1A) for generating predictive data 160, according to certain embodiments. The system 300 is used to determine predictive data 160 (e.g., via model 190 of FIG. 1A) to determine prequalification of users and display properties for which the users are prequalified.

At block 310, the system 300 performs data partitioning (e.g., via data set generator 172 of server machine 170 of FIG. 1A) of the historical data (e.g., historical property data 144, historical user data 154, and/or historical sensor data 164 of FIG. 1A) to generate the training set 302, validation set 304, and testing set 306. In some examples, the training set is 60% of the historical data, the validation set is 20% of the historical data, and the testing set is 20% of the historical data. The system 300 generates a plurality of sets of features for each of the training set, the validation set, and the testing set. In some examples, if the historical data includes features derived from property data and/or user data from 20 entities (e.g., properties and/or users) and 100 iterations (e.g., renter scores, threshold scores, bids, agreements, etc. that each correspond to a property and/or user of the 20 entities), a first set of features is entities 1-10, a second set of features is entities 11-20, the training set is scores 1-60, the validation set is scores 61-80, and the testing set is iterations 81-100. In this example, the first set of features of the training set would be data from entities 1-10 for iterations 1-60.

At block 312, the system 300 performs model training (e.g., via training engine 182 of FIG. 1A) using the training set 302. In some embodiments, the system 300 trains multiple models using multiple sets of features of the training set 302 (e.g., a first set of features of the training set 302, a second set of features of the training set 302, etc.). For example, system 300 trains a machine learning model to generate a first trained machine learning model using the first set of features in the training set (e.g., data from entities 1-10 for iterations 1-60) and to generate a second trained machine learning model using the second set of features in the training set (e.g., data from entities 11-20 for iterations 1-60). In some embodiments, the first trained machine learning model and the second trained machine learning model are combined to generate a third trained machine learning model (e.g., a better predictor than the first or the second trained machine learning model on its own in some embodiments). In some embodiments, sets of features used in comparing models overlap (e.g., first set of features being data from entities 1-15 and second set of features being entities 5-20). In some embodiments, hundreds of models are generated including models with various permutations of features and combinations of models.

At block 314, the system 300 performs model validation (e.g., via validation engine 184 of FIG. 1A) using the validation set 304. The system 300 validates each of the trained models using a corresponding set of features of the validation set 304. For example, system 300 validates the first trained machine learning model using the first set of features in the validation set (e.g., data from entities 1-10 for iterations 61-80) and the second trained machine learning model using the second set of features in the validation set (e.g., data from entities 11-20 for iterations 61-80). In some embodiments, the system 300 validates hundreds of models (e.g., models with various permutations of features, combinations of models, etc.) generated at block 312. At block 314, the system 300 determines an accuracy of each of the one or more trained models (e.g., via model validation) and determines whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. The system 300 discards the trained machine learning models that have an accuracy that is below the threshold accuracy (e.g., based on the validation set).

At block 316, the system 300 performs model selection (e.g., via selection engine 185 of FIG. 1A) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow returns to block 312 where the system 300 performs model training using further refined training sets corresponding to further refined sets of features for determining a trained model that has the highest accuracy.

At block 318, the system 300 performs model testing (e.g., via testing engine 186 of FIG. 1A) using the testing set 306 to test the selected model 308. The system 300 tests, using the first set of features in the testing set (e.g., data from entities 1-10 for iterations 81-100), the first trained machine learning model to determine the first trained machine learning model meets a threshold accuracy (e.g., based on the first set of features of the testing set 306). Responsive to accuracy of the selected model 308 not meeting the threshold accuracy (e.g., the selected model 308 is overly fit to the training set 302 and/or validation set 304 and is not applicable to other data sets such as the testing set 306), flow continues to block 312 where the system 300 performs model training (e.g., retraining) using different training sets corresponding to different sets of features (e.g., data associated with different properties and/or users). Responsive to determining that the selected model 308 has an accuracy that meets a threshold accuracy based on the testing set 306, flow continues to block 320. In at least block 312, the model learns patterns in the historical data to make predictions and in block 318, the system 300 applies the model on the remaining data (e.g., testing set 306) to test the predictions.

At block 320, system 300 uses the trained model (e.g., selected model 308) to receive current property data 146 and/or current user data 156 and determines (e.g., extracts), from the output of the trained model, predictive data 160 to prequalify users for properties and display the properties for which the user is prequalified. In some embodiments, the current property data 146 and/or current user data 156 corresponds to the same types of features in the historical data. In some embodiments, the current property data 146 and/or current user data 156 corresponds to a same type of features as a subset of the types of features in historical data that are used to train the selected model 308.

In some embodiments, current data is received. In some embodiments, current data includes current score data 166. The model 308 is re-trained based on the current data. In some embodiments, a new model is trained based on the current data (e.g., current property data 146, current user data 156, and/or current score data 166).

In some embodiments, one or more of the operations 310-320 occur in various orders and/or with other operations not presented and described herein. In some embodiments, one or more of operations 310-320 are not be performed. For example, in some embodiments, one or more of data partitioning of block 310, model validation of block 314, model selection of block 316, and/or model testing of block 318 are not performed.

FIGS. 4A-E illustrate flow diagrams of methods 400A-E associated with prequalifying users (e.g., dynamic access analysis verification and prepopulated authentication), according to certain embodiments. In some embodiments, methods 400A-E are performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In some embodiment, one or more of methods 400A-E are performed, at least in part, by one or more of predictive system 130, prequalification system 110, prequalification component 112, user device 120, and/or administrator device 122 of FIG. 1A. In some embodiments, method 400A is performed, at least in part, by predictive system 130 (e.g., server machine 170 and data set generator 172 of FIG. 1A, data set generator 172 of FIG. 2). In some embodiments, predictive system 130 uses method 400A to generate a data set to at least one of train, validate, or test a machine learning model. In some embodiments, methods 400B and 400E are performed by prequalification component 112 (e.g., prequalification system 110, user device 120, and/or administrator device 122). In some embodiments, method 400C is performed by server machine 180 (e.g., training engine 182, etc.). In some embodiments, method 400D is performed by predictive server 132 (e.g., predictive component 134). In some embodiments, a non-transitory machine-readable storage medium stores instructions that when executed by a processing device (e.g., of predictive system 130, of server machine 180, of predictive server 132, user device 120, administrator device 122, etc.), cause the processing device to perform one or more of methods 400A-E.

For simplicity of explanation, methods 400A-E are depicted and described as a series of operations. However, operations in accordance with this disclosure can occur in various orders and/or concurrently and with other operations not presented and described herein. Furthermore, in some embodiments, not all illustrated operations are performed to implement methods 400A-E in accordance with the disclosed subject matter. In addition, those skilled in the art will understand and appreciate that methods 400A-E could alternatively be represented as a series of interrelated states via a state diagram or events.

FIG. 4A is a flow diagram of a method 400A for generating a data set for a machine learning model for generating predictive data (e.g., predictive data 160 of FIG. 1A), according to certain embodiments.

Referring to FIG. 4A, in some embodiments, at block 401 the processing logic implementing method 400A initializes a training set T to an empty set.

At block 402, processing logic generates first data input (e.g., first training input, first validating input, first testing input, etc.) that includes historical property data and/or historical user data. In some embodiments, the first data input includes a first set of features for types of property data and/or user data and a second data input include a second set of features for types of property data and/or user data (e.g., as described with respect to FIG. 2).

At block 403, processing logic generates a first target output for one or more of the data inputs (e.g., first data input). In some embodiments, the first target output is historical score data (e.g., renter score, threshold renter score, etc.). In some embodiments, the historical score data is associated with displaying of properties for which a user is prequalified.

At block 404, processing logic optionally generates mapping data that is indicative of an input/output mapping. The input/output mapping (or mapping data) refers to the data input (e.g., one or more of the data inputs described herein), the target output for the data input (e.g., where the target output identifies historical score data), and an association between the data input(s) and the target output.

At block 405, processing logic adds the mapping data generated at block 404 to data set T.

At block 406, processing logic branches based on whether data set T is sufficient for at least one of training, validating, and/or testing machine learning model 190. If so, execution proceeds to block 407, otherwise, execution continues back at block 402. It should be noted that in some embodiments, the sufficiency of data set T is determined based simply on the number of input/output mappings in the data set, while in some other implementations, the sufficiency of data set T is determined based on one or more other criteria (e.g., a measure of diversity of the data examples, accuracy, etc.) in addition to, or instead of, the number of input/output mappings.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, machine learning model (e.g., machine learning model 190) can be at least one of trained using training engine 182 of server machine 180, validated using validating engine 184 of server machine 180, or tested using testing engine 186 of server machine 180. The trained machine learning model is implemented by predictive component 134 (of predictive server 132) to generate predictive data 160 for displaying properties for which users are prequalified.

FIG. 4B is a flow diagram of a method 400B associated with prequalification of users for properties, according to certain embodiments.

Referring to FIG. 4B, at block 420 processing logic identifies property data associated with properties. In some embodiments, the property data comprises one or more of property location data, property size data, property amenity data, property building type data, or property image data captured by an imaging device.

At block 422, processing logic identifies user data associated with one or more users. In some embodiments, the user data comprises one or more of financial data, employer data, historical rental data, current rental data, or payment history data. In some embodiments, the identifying of the user data comprises retrieving, via an application programming interface (API), the user data from one or more sources.

In some embodiments, the one or more users comprise one or more of: a user; a group of users; or the user and a guarantor. The user data may include: guarantor data associated with a relationship between the user and the guarantor; and/or percentage of rent responsible by the guarantor.

At block 422, processing logic determines, based on the property data and the user data, that the one or more users are prequalified for a subset of the properties. In some embodiments, the processing logic uses a trained machine learning model to determine the one or more users are prequalified for the subset of the properties (e.g., see FIGS. 4C-D).

At block 422, processing logic causes a graphical representation of the subset of the plurality of properties to be displayed via a user device to the one or more users.

In some embodiments, to cause the graphical representation of the subset of the plurality of properties to be displayed, the processing logic is to cause display of a virtual reality tour of each of the subset of the plurality of properties.

In some embodiments, to cause the graphical representation of the subset of the plurality of properties to be displayed, the processing logic is to cause display of interaction data of a property of the subset of the properties. The interaction data may include one or more of: quantity of users looking at the property; quantity of applications submitted for the property; quantity of favorites associated with the property; quantity of unique property listing reviews of the property; or reviews of the property, owner, or landlord.

In some embodiments, the processing logic is further to determine a first rent amount of a first property of the properties by comparing first property data of the first property to corresponding property data of one or more of the properties. To cause the graphical representation of the subset of the properties to be displayed, the processing logic is to cause display of the first rent amount of the first property.

In some embodiments, the processing logic is further to receive user input selecting a property of the subset of the plurality of properties; prepopulate, based on at least a portion of the user data of the one or more users, a digital application; and transmit the digital application to an administrative device for approval of the digital application.

In some embodiments, the processing logic is further to receive user input selecting a property of the subset of the properties and dynamically authorize the one or more users to rent the property without an application.

In some embodiments, the processing logic is further to automatically retrieve payment from a financial account of the one or more users and automatically create an executed digital lease (e.g., cause the digital lease to be executed via blockchain) and renting the property to the one or more users without transmitting the user data to an administrator device associated with the property.

In some embodiments, to cause the graphical representation of the subset of the properties to be displayed, the processing logic is to cause display of a rent amount and a bid option associated with a first property of the subset. The processing logic may further: display one or more of: a quantity of bids associated with the first property and a current bid amount (e.g., highest current bid amount for the property); or a range of current bids; receive, from the user device, bid data associated with the bid option; responsive to the bid data meeting the rent amount or a predetermined amount of time passing after the receiving of the bid data, select the bid data; and transmit, to the user device, acceptance data.

In some embodiments, responsive to determining that the user device is within a predetermined distance of a digital lock device associated with a property, the processing logic is to cause the digital lock device to unlock. In some embodiments, the digital lock device is associated with access to one or more of the property, an amenity (e.g., pool, exercise room, conference room, activity center, etc.), or a door (e.g., to the property, to the amenity, to a room, to a closet, etc.). The processing logic may further determine that the access is to be accessible by the user device based on rent level associated with the user device.

In some embodiments, the processing logic is further to: receive a transfer request to transfer a property from a first user to a second user; and responsive to determining that a second renter score of the second user meets a threshold renter score for the property, cause the property to be transferred from the first user to the second user.

In some embodiments, the processing logic is further to: receive image data associated with a property of the plurality of properties; and dynamically determine, based on the image data, at least one of a rent amount for the property or a threshold renter score for the property.

In some embodiments, the processing logic is further to: authenticate, via a secondary account of the user, a user to enter a primary account associated with the plurality of properties; extract user information associated with the user from the secondary account; and verify, based on the user information extracted from the secondary account, at least a portion of the user data entered by the user.

In some embodiments, blocks 420-422 are repeated to update the graphical representation displayed via the user device based on updates to property data and/or user data.

In some embodiments, the processing logic performs dynamic access analysis and prepopulated authentication. In some embodiments, a user can access the prequalification system (e.g., the processing logic, method 400B) via a web application and/or a mobile application. The web application can be embedded in a webpage. The processing logic can cause a prompt to be displayed via the user device of the user to prompt the user to login to an account or sign up for the prequalification system. In some embodiments, the processing logic can prompt the user for a username and/or password. In other embodiments, the user can use Fast IDentity Online (FIDO) to log in to an account or sign up for the prequalification system. In some embodiments, the user can use a secondary account associated with a web platform or any social media, such as Google, Apple, Facebook, Microsoft, and/or Yahoo. In some embodiments, the processing logic can automatically and dynamically extract or retrieve information from the secondary account. The system can extract or the user can input a name of the user, a phone number of the user, an email of the user, a date of birth of the user, an address of the user, a previous address of the user, a gender of the user, and/or any other information associated with the user. In some embodiments, the processing logic can use information from the secondary account to verify information entered by the user.

In some embodiments, if the user does not have an account, the processing logic can prompt the user to create an account. The processing logic can prompt or request the user enter in contact information, employment information and financial information. In some embodiments, the processing logic can automatically retrieve the contact information, the employment information, and the account information via an API. The contact information can include the user's legal name, a phone number, a date of birth, and/or a current address. The employment information can include a user's current employer, current salary, a bonus amount, or any other employment information. In some embodiments, the processing logic can retrieve financial information for a third-party system (e.g., data source system 114 and/or data source component 116 of FIG. 1A). The third-party system can be any digital financial data API (e.g., user data API 102 of FIG. 1B), such as Plaid. The processing logic can retrieve financial information of the user, such as bank account numbers, an online banking user identification, an account type, total assets, income, rent payments, bank account balances, or any other relevant financial information. In some embodiments, the processing logic can retrieve the financial information, and the processing logic can use artificial intelligence (AI) and/or machine learning (ML) to automatically identify transaction types. For example, a machine learning model can be trained using data input including historical transactions (e.g., financial information received via an API, such as user data API 102 of FIG. 1B) and target output including historical types associated with historical transactions to generate a trained machine learning model. Then, processing logic may provide the transactions (e.g., financial information) as input to the trained machine learning model and receive, from the machine learning model, output associated with predicted types of the transactions (e.g., to automatically identify transaction types).

In some embodiments, the processing logic can prompt the user to provide information associated with a guarantor. The information associated with the guarantor can include any information associated with the user such as contact information, employment information and financial information. In some embodiments, the information associated with the guarantor can include a relationship of the user and the guarantor, and a percentage of rent for which the guarantor is to be responsible.

In some embodiments, the processing logic may prompt a user to submit the data to the prequalification system (e.g., provide the data to the processing logic) prior to retrieving the information from the third-party system. The processing logic can include one or more data security features such as data encryption.

In some embodiments, the processing logic can use the employment information and/or the financial information for dynamic verification. In some embodiments, the processing logic can automatically calculate a renter score based on the financial information, and employment information. The processing logic can calculate a renter score based on both the user and the guarantor. In some embodiments, the processing logic can calculate multiple renter scores. For example, the processing logic can calculate a renter score based on only the user, and a second renter score based on the user and the guarantor.

The renter score can be based on current income, previous rental information, such as evictions or late payments of rent, and/or a current rent. In some embodiments, the renter score can be based on a set of rules. In some embodiments, the renter score can be determined by artificial intelligence and/or a machine learning algorithm (e.g., see FIGS. 4C-D). In some embodiments, the renter score can be based on 40 times the current income of the user and/or the guarantor. In some embodiments, the renter score can be based on the user and other users. The user and other users can join a group. The renter score can be based off a combined income, or any other combined previous rental information, and/or current combined rent.

In some embodiments, the processing logic can request the user invite the other users and/or the guarantor. The processing logic can add the guarantor after the guarantor has accepted the invitation. In some embodiments, the invitation can be sent to the guarantor via email, text message, push notification, or any other form of communication.

In some embodiments, the processing logic can use the renter score to determine one or more apartments the user and/or the group qualify for. Each of the one or more apartments can be selected from a database of apartments. Each of the apartments in the database of apartments can include a minimum renter score. The minimum renter score can be entered by a leasing agent, landlord, or owner of each apartment. In some embodiments, the processing logic can automatically determine a minimum renter score. The minimum renter score can be based on a location of the apartment, a square footage, a room number, one or more amenities, a building type, and analysis of one or more pictures of the apartment via a computer vision algorithm.

In some embodiments, the processing logic can display the one or more apartments the user and/or the group qualify for based on comparing the renter score to the minimum renter score. If the renter score is greater than the minimum renter score, the processing logic can display the apartment to the user and/or the group. In some embodiments, the processing logic can display one or more apartments to users that have rented an apartment from the system previously. In some embodiments, renting an apartment from the system and paying rent on time can increase a user's renter score. In some embodiments, the display can include a virtual reality tour of each apartment. In some embodiments, the processing logic can display to the user or to the one or more interactions for each apartment listing. The interactions can include a number of users looking at the apartment, a number of applications submitted, a number of favorites, a number of unique apartment listing views, and one or more reviews of the apartment, the owner, and/or the landlord.

In some embodiments, the processing logic can display a rent amount for each apartment. The rent amount can be input by the leasing agent, landlord, or owner of each apartment. In other embodiments, the processing logic can automatically generate the rent amount. The processing logic can calculate the rent amount based on property data (e.g., apartment information). The property data (e.g., apartment information) can include a location of the apartment, a square footage, a room number, one or more amenities, a building type, and analysis of one or more pictures of the apartment via a computer vision algorithm. In some embodiments, the processing logic can compare the apartment information of each apartment to the apartment information of other apartments in the database, or apartments in third-party systems. The processing logic can access rental information from third-party systems via an API. The processing logic can automatically and dynamically update the rent amount each time the apartment is listed for rent.

In some embodiments, the leasing agent, landlord, or owner of an apartment can input the apartment into the prequalification system (e.g., provide the information to the processing logic). The processing logic can prompt the leasing agent, landlord, or owner to input a building identification, a building name, a building address, a building manager, an apartment number, an apartment name, a number of rooms, a square footage, a building year, apartment renovation information, and/or a rent amount.

The user and/or the group can select an apartment to rent from the one or more apartments. In some embodiments, the processing logic can generate a digital application with at least a portion of the digital application automatically completed by the processing logic. The processing logic can use information from an account of the user and/or the group to prepopulate authentication. The processing logic can complete at least the portion of the digital application. The processing logic can request the user and/or the group to enter any information to complete any portion of the digital application not completed by the processing logic. After the digital application is completed, the processing logic can automatically and dynamically send the digital application to the rental agent, the landlord, and/or the owner for approval of the application.

In some embodiments, the processing logic can dynamically authorize the user, and the user can rent an apartment without an application. The user can enter credit card information, bank account information, blockchain wallet information, or the system can automatically retrieve payment information via the digital financial data API. When the user selects an apartment to rent from the one or more apartments the user qualifies for, the processing logic can automatically retrieve payment for rent, a broker's fee, a security deposit, and/or any other relevant payment. The processing logic can automatically create an executed digital lease and rent the selected apartment to the user. In some embodiments, the user can rent the apartment and the system can create the execute digital lease without transmitting the employment data, financial data and/or payment information to the rental agent, the landlord and/or the owner. In some embodiments, the processing logic can transmit only the renter score to the rental agent, the landlord and/or the owner. In this way, the processing logic can maintain the user's privacy. In some embodiments, the processing logic can automatically transmit a notification to the leasing agent, landlord, or owner. In some embodiments, the digital lease can be executed via the blockchain.

In some embodiments, the user can bid on a property (e.g., an apartment). The processing logic can display the rent and an option to for the user to bid. Multiple users can bid on the apartment. In some embodiments, bidding can last until one of the multiple users bids the rent amount. In some embodiments, bidding can last for a predetermined amount of time, and a bid amount can be higher than the rent amount. In some embodiments, the system can display a number of bids on each apartment listing, and a current bid amount. In some embodiments, the system uses a semi-blind auction that allows a user to see a range of other bids, but not if the user is winning or not. The administrator may decide which offer (e.g., bid) to select at the end of the auction time.

In some embodiments, the user can use a computing device, such as a mobile phone or other mobile computing device to unlock one or more doors for the apartment. The processing logic can automatically retrieve information from a digital lock of the selected apartment. The information can include an apartment identification, and an apartment name. The processing logic can access a memory of the user computing device and store or download the information on the memory. The user can use Near Field Communication (NFC), Radio Frequency Identification (RFID), Bluetooth®, or any other communication network to transmit the information to the digital lock when the user device (e.g., user computing device, smartphone, etc.) is within a predetermined distance of the digital lock. The processing logic can automatically unlock and/or lock the digital lock when the user device (e.g., computing device) is near the digital lock.

In some embodiments, the processing logic can require authentication before the processing logic unlocks the digital lock. The processing logic can prompt the user to input a password, a numerical code, and/or biometric authentication (e.g., fingerprint, face recognition via an imaging device, etc.). The processing logic can determine whether to unlock or lock the digital lock based on the authentication of the user.

In some embodiments, the processing logic can use the digital lock to control access to amenities of an apartment building. Each apartment listing can include multiple rent levels for the apartment. Each of the rent levels can include access to different amenities such as a pool, rooftop access, or any other amenity. Based on which rent level a user selects, the processing logic can transmit amenity information to the user device (e.g., user computing device). The processing logic can use the amenity information to unlock one or more digital locks associated with the amenities included in the user's selected rent level.

In some embodiments, the user can transfer a rented apartment to a second user. The processing logic can prevent the user from transferring the rented apartment to the second user if the second user's renter score is below the minimum renter score for the apartment. In some embodiments, the user can select a second apartment to rent, and stop renting the rented apartment. The processing logic can automatically update the information and amenity information based on the selection of the second apartment. In some embodiments, the processing logic can automatically renew the lease.

In some embodiments, the user can submit one or more maintenance or service calls to the processing logic (e.g., prequalification system). The processing logic can automatically request a maintenance person to fulfill the submission. The processing logic can automatically send the maintenance person information associated with the apartment and the call. In some embodiments, the maintenance person can access the prequalification system (e.g., the processing logic) via a mobile application.

In some embodiments, the processing logic can automatically provide the owner and the renter with insurance. In some embodiments, the insurance can be a third-party insurance provider.

In some embodiments, the user can select to remove the account from the prequalification system (e.g., the processing logic). When the user selects to remove the account, the processing logic can delete the contact information, employment information, and account information. In some embodiments, the digital financial data API can instruct the processing logic to delete the contact information, employment information and account information.

FIG. 4C is a method 400C for training a machine learning model (e.g., model 190 of FIG. 1A) for determining predictive data (e.g., predictive data 160 of FIG. 1A) for displaying properties for which users are prequalified, according to certain embodiments.

At block 440 processing logic identifies at least one of historical property data associated with historical properties and/or historical user data associated with historical users.

At block 440 processing logic identifies historical score data including at least one of historical renter score data of the historical users and/or historical threshold renter score data of the historical properties.

At block 440 processing logic trains a machine learning model using data input including the historical user data and target output including the historical score data to generate the trained machine learning model.

FIG. 4D is a method 400D for using a trained machine learning model (e.g., model 190 of FIG. 1A) for determining predictive data to display properties for which users are prequalified, according to certain embodiments.

At block 460, processing logic identifies current data (e.g., current property data associated with properties and/or current user data associated with users).

At block 462, processing logic provides the current data as input to a trained machine learning model.

At block 464, processing logic obtains, from the trained machine learning model, one or more outputs indicative of predictive data.

At block 466, processing logic determines, based on the predictive data, that renter score data associated with the one or more users meets threshold renter score data of each of the subset of the plurality of properties.

At block 468, processing logic identifies current score data associated with the current data.

At block 470, the processing logic causes the trained machine learning model to be further trained (or re-trained) with data input including the current data (e.g., current property data and/or current user data) and target output including the current score data.

In some embodiments, blocks 460-470 are repeated until the one or more outputs (e.g., predictive data) indicates that no further updates to the graphical representation of the properties for which the user is qualified.

FIG. 4E is a method 400E associated with using score data (e.g., renter score) for prequalification of users, according to certain embodiments.

At block 450, the processing logic determines whether a secondary account (e.g., financial account, bank account) is connected to a primary account (e.g., property rental account). This may be responsive to the processing logic starting the onboarding process (e.g., user setup in the property rental system/prequalification system). Responsive to the secondary account being connected to the primary account, flow continues to block 452. Responsive to a secondary account not being connected to the primary account, flow continues to block 458.

At block 452, the processing logic builds a financial model based on user data (e.g., financial data) from the secondary account.

At block 454, the processing logic determines whether a renter score can be calculated based on the financial model. Responsive calculating the renter score based on the financial model, flow continues to block 462. Responsive to not being able to calculate the renter score based on the financial model, flow continues to block 456.

At block 456, the processing logic determines whether an additional secondary account (e.g., additional financial account) can be added. Responsive to adding an additional secondary account, flow returns to block 452. Responsive to not being able to add an additional secondary account, flow continues to block 458.

At block 458, the processing logic obtains financial statements (e.g., upload statements, upload paystubs) associated with the user. This may be part of a manual verification process.

At block 460, the renter score is determined based on the financial statements. This may be part of submitting the financial data for review, undergoing manual administrative verification, and manually updating (e.g., determining) the renter score.

At block 462, the processing logic may obtain additional data, such as continuing to receive user input to edit the profile of the primary account, adding another account to the primary account, adding one or more co-signers, adding one or more guarantors, and/or the like.

At block 464, the processing logic determines, based on the rental score, a subset of the properties for which the user is prequalified.

At block 466, the processing logic causes a graphical representation fo the subset of the properties to be displayed via a user device to the user. In some embodiments, the processing logic provides an option to submit an auction offer (e.g., bid) or to select (e.g., click) rent now (e.g., enter into a rental agreement now).

At block 468, the processing logic receives, from the user device, user selection of a property of the subset of the properties. In some embodiments, the user selection is an auction offer (e.g., bid). In some embodiments, the user selection is associating with renting now the property.

At block 470, the processing logic provides an indication of the user selection to an administrator device (e.g., updates the agent and/or owner) associated with the property.

In some embodiments, processing logic determines an initial renter score per user and may add potential additional data points. The renter score may be a multi-dimensional score that is based on both the financial qualification of the user and the behavioral qualification of the user (e.g., potential tenant).

In some embodiments, connected secondary accounts (e.g., connected bank accounts via Plaid integration) may be used. In some embodiments, the processing logic obtains (e.g., pulls) a threshold amount of transactions (e.g., past 12 months of transactions). In some embodiments, multiple secondary accounts of different types (e.g., checking account, savings account, investment accounts, overseas/foreign bank accounts, currencies, etc.). In some embodiments, if a user declines to connect at least one secondary account, the user may not be able to complete the registration process and an administrator may manually review any supporting materials to determine the financial qualification.

For a user that already has a primary account (e.g., with the prequalification system), in addition to the connected secondary account, the processing logic may analyze ongoing rent payments and communication with management of properties (e.g., ticket analysis.

Transactional data may be analyzed and sorted into a monthly model, where each month (e.g., ignoring current month as it is not complete) includes one or more of: debt (e.g., total expenses); credit (e.g., total deposits); free cash (e.g., equals credit minus debit); post balance (e.g., account balance at the end of each month); income (e.g., payroll deposits); and/or rent (e.g., any payment labeled as rent payment by bank).

The renter score may include a financial score component. The financial score component may be a quantitative measure and may be used to estimate the maximum rent amount a user (e.g., potential renter, potential tenant) can afford each month. This measurement can be aggregated when evaluating a group of co-signers and/or guarantors.

A weighted average may be used based on weights for both free cash flow and average balance analysis. The free cash may be taken with rent payments rent payments removed from the total debit to neutralize these expenses.

The renter score may be calculated as:

FScore=Sumproduct(RENT_FREE_CASH,Weights)+Sumproduct(POST_BALANCE,Weights)

Weights used may be a linear decay, but other types may be used for training sets.

If a user has multiple accounts, the renter score (e.g., FScore) may be calculated per account and aggregated).

The renter score may include a behavioral component. The behavioral component may illustrate how responsible the user (e.g., prospective tenant) is in their financial handling and may be used to produce a renter score that is per user (e.g., tenant) and may be taken individually when analyzing a group of co-signers/guarantors.

One or more of the following factors may be analyzed to determine the behavioral component of the renter score:
1) Rent payments: since some payments may end up in the same month and some could be partial, the median payment may be used. If not zero, then the sum of the all the rents may be divided by median. For example: round (sum (Rent_Array)/MEDIAN(Rent_Array)).
2) Income stability: count the number of months with income and sum the corresponding weights. For example: sumif(INCOME_ARRAY, “>0”, WEIGHTS_ARRAY).
3) Balance management (e.g., trend analysis): linear regression may be used to see how consistent the trend of the balance is. If the line is horizontal (e.g., no real correlation between time and balance), then it is determined whether the trend is ascending or descending. The R2 may be computed using LINEST. For example: if(R2<0.1,if(SLOPE>=0,0.75,0.75+(SLOPE*30*12/ACCOUNT_BALANCE)),SIGN(SLOP E)*R2).
4) Savings analysis: if the trend is negative, it may be examined how fast the savings will be used based on the slope of the trendline. For example: if(SLOPE<0,max(0,1+(SLOPE*30*12/ACCOUNT_BALANCE)),1).
5) Overdraft months: for example: COUNTIF(BALANCE_ARRAY,“<0”)*−0.1

The renter score and/or the behavioral component of the renter score may be the average of one or more of the above factors (e.g., rent payments, income stability, balance management, savings analysis, and/or overdraft months). Weights may be added if some factors are more important.

In some embodiments, the behavioral component is a percentage and the financial score component is an amount of money.

In some embodiments, multiple accounts (e.g., multiple checking and savings accounts) may be used.

In some embodiments, an administrator (e.g., owner or agent of a property) may have different controls for determining renter score. The administrator may have controls to set for a fully automated process so that they do not review and approve individual users (e.g., renters, tenants), but instead set thresholds (e.g., minimum renter score) and any potential tenant that passes that initial threshold can initiate the contract process directly within the prequalification system (e.g., the mobile application, the desktop application, etc.).

The financial score may be implicit controls and may be the set market rent amount requested per property. The behavioral control may be per administrator (e.g., owner) and/or per one or more properties (e.g., per building) and is a set percentage under which prospective tenants will not be able to rent.

In some embodiments, soft signals may be used, such as one or more of: sentiment analysis of tenant-owner-system communications; number of tickets generated compared to building average; owner review score; and/or the like.

In some embodiments, the processing logic provides an employment and assets verification tool (e.g., broker tool, tools for design partner property management). This may allow administrators to manually adjust and manage exceptions and edge cases.

The administrator tools may be used by owner, agent, and/or administrators. An owner can view owned properties (e.g., manage on back-office side), view and/or manage invitations, and/or view applications (e.g., see underlying users aggregate data). An agent may view a list of assigned properties, view and/or manage invitations, and/or view an application (e.g., view underlying user status). An administrator may view and/or manage owned properties (e.g., manage may be temporary, may be integrated to backoffice), view and/or manage invitations, and/or view applications (e.g., see underlying user specific data).

Property data may include one or more of: unit number (e.g., text and/or number, such as A1, 13, etc.); building (e.g., separate table, full address, other common features); current list price; owner; agent(s); and/or attribute(s).

An application may be prepopulated based on user data and/or property data. The application may include one or more of:
unit plus building;
submitted timestamp (e.g., when first user clicked submit, other cosigners may still be working);
price (e.g., list price);
user(s) (e.g., all approved users in this group) including name, status (has data, no data, exception), assets total, income (e.g., year to date (net), estimated yearly (net), sample start (date)), and/or supporting documents;
guarantor[s] (same fields as user(s)); and/or
status (e.g., qualified, not qualified, risk, etc.).

In some embodiments, the processing logic provides an administrator view that includes property data (e.g., address, rent amount), user data (e.g., name, assets, YTD (net), estimated yearly (net), sample start), a recommendation of whether to approve or deny (e.g., based on renter score and a threshold renter score), and an option to approve or deny each user.

In some embodiments, the processing logic provides an auction option (e.g., bid on a property). The processing logic may allow users to enter an offer and see a status of their bid. In some embodiments, the processing logic may allow a user to see a range of other bids, but not the status of their own bid (e.g., not whether the user has the highest bid or not). Alongside the bidding option, each property may have a “rent now” option (e.g., “instant rent” option) at a price X % above asking price.

Once an auction is concluded, the winning bid application is approved and the renter is notified that they can start the checkout process.

The prerequisite may include a renter score that meets a threshold renter score. This may improve rent detection, may be implemented via an aggregated score across multiple accounts, and/or may build a tolerance/threshold or alternative fallback if data is not sufficient. There may be a personalized view for each user, where in search and property view, an indication of “pre-qualified” or “pending qualification” may be displayed based on personal co-signer group score. There may not be an option to vary the lease start date.

For the user side, the bidding process may be managed from the unit details page. Once a user submits a bid, the default view for the user is the details page as long as the auction is live. Units that do not have a live action may have a “submit an application button.” Units that have live actions may have a user interface that includes one or more of: photos; virtual tour; address; amenities; description; an indication that applications are being accepted; an application close time; current offer; an option to provide an offer; status of your offer; and/or an option to rent now for a particular amount (e.g., 10% higher than the current offer).

On the administrator side, an auction may be part of a unit. The owner may be able to setup: a start date/time (e.g., where auction will be live); end date/time (e.g., auction closes and winning bid determined); rent now price (e.g., fixed or a percentage); lease start date; starting price; and/or application fee (optional). In the unit page, the owner may see a number of bids and a current winning bid.

There may be an application fee. There may not be a strong way to force users that submitted a winning bid to sign and pay the lease. The application fee may be a way to encourage a serious intent from the user. The application fee may be non-refundable. When a user submits the bid, a pop-up text may indicate that there is a fee to pay and once paid the offer will be recorded and status updated. If no application fee is defined in the auction, selecting submit may open a confirmation popup and once the user confirms, the offer will be entered.

In some embodiments, on unit page load, if the auction is open (time greater than zero), then an auction user interface is displayed. If rent now is enabled, a rent now button is displayed. Responsive to the auction ending, if the winning bid is greater than the list price, the unit is hidden and notifications are sent (e.g., to the winning bidder, to the administrator, to the bidders that did not win, etc.).

Responsive to user selection of rent now, a popup may be displayed, upon under input confirming, the rent now option may be set to false. A lease may be created with start date and rent now price. The user may be taken to MyHome, and a timer may be started. If the user completes payment with the time frame of the timer, the auction may be closed and notifications may be sent to all bidders. If the timer elapses with no payment, then the rent now button is enabled (e.g., according to regular logic). Based on the rent now logic, if no bids are made and the rent now amount is set, the rent now button may be displayed. The rent now button may be disabled if (highest bid minus list price)≥(rent now price minus list price)/2.

In some embodiments, the administrative device may display an administrative view (e.g., from owner perspective, payments and/or ledger views). The administrative view may include data on a specific owner unit and not user level raw data (e.g., bank accounts, assets, etc.). The renter score may be shown (e.g., aggregation of user data).

The administrative view may include one or more of dashboard, applications, invitations page, properties (e.g., imported or created properties), units, leases (e.g., names, without link to user), users (e.g., only aggregate score data, no assets or bank accounts, cannot see uploaded documents), payments (e.g., see all payments, filter by date, payment method), maintenance (e.g., see tickets for all units/leases for that owner), settings, and/or building communications (comms). The dashboard may include a snapshot of one or more areas, such as a grid of boxes with a preview to: recent payments (e.g., last 5-10); recent applications; upcoming renewals (e.g., list of units and move out date); and/or recent invitations sent (e.g., unit user, date, etc.). The applications may be for non-qualified users or for bid/term changes. For pre-qualified users, a dummy application object may be displayed that is created automatically when the user selects the rent button. The page may show an aggregated score and not individual assets. The settings may include threshold renter scores (e.g., minimum renter scores, 0-100 scale, etc.), user and/or team managements (e.g., add/remove team members), financial entities (e.g., owners, multiple legal entities for buildings), block users with owner flag, criminal background checks controls (e.g., categories to ignore, require yes/no), and/or notification settings (e.g., which payment related events to get, application events, etc.). Building comms may include bulletin boards, send message form (e.g., control which units receive by floor, line, unit, etc.).

The processing logic may also provide a broker view. For a broker only user view, the following subset of pages may be available applications and invitations page (e.g., able to select only units associated with the user). The applications may include applications for non-prequalified users or for bid/term changes and dummy applications (e.g., generated automatically) for users that select the rent button.

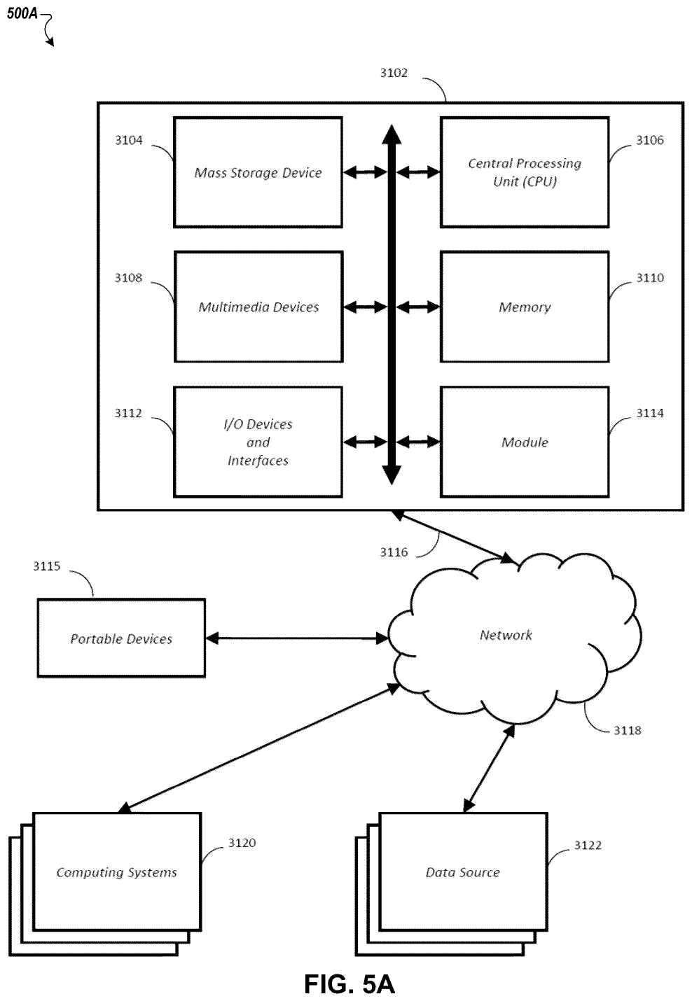

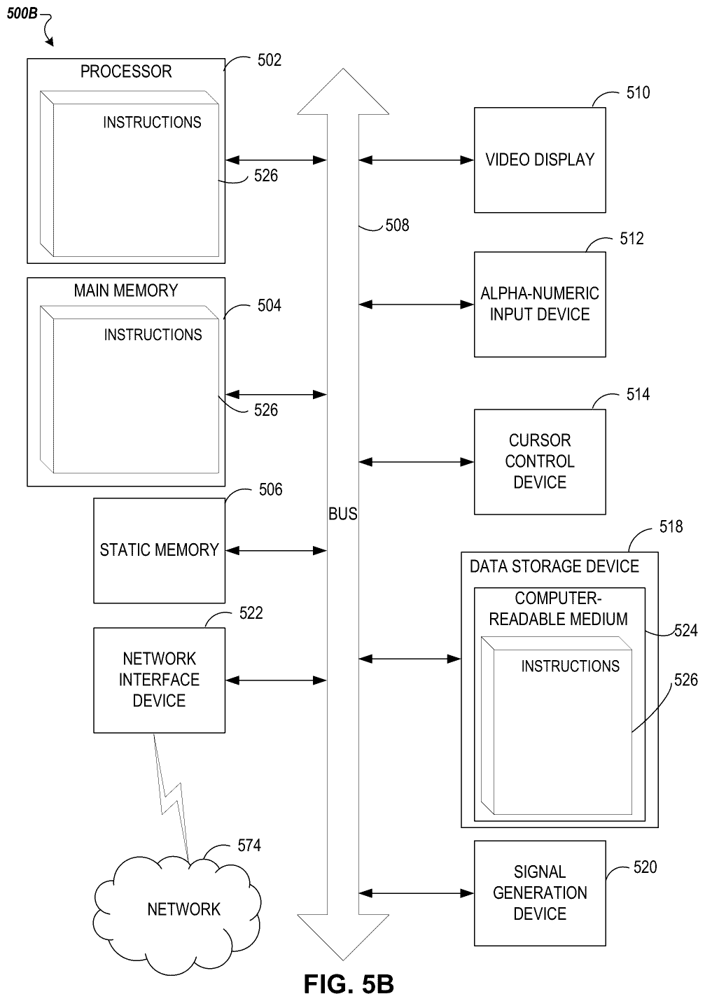

FIGS. 5A-B are block diagrams illustrating a computer system 500A-B, according to certain embodiments.

FIG. 5A is a block diagram depicting an embodiment of a computer system 500A (e.g., computer hardware system) configured to run software for implementing one or more embodiments disclosed herein.

In some embodiments, the systems, processes, and methods described herein are implemented using a computing system, such as the one illustrated in FIG. 5A. The example computer system 3102 is in communication with one or more computing systems 3120 and/or one or more data sources 3122 via one or more networks 3118. While FIG. 5A illustrates an embodiment of a computing system 3102, it is recognized that the functionality provided for in the components and modules of computer system 3102 may be combined into fewer components and modules, or further separated into additional components and modules.

The computer system 3102 can comprise a module 3114 that carries out the functions, methods, acts, and/or processes described herein. The module 3114 is executed on the computer system 3102 by a central processing unit 3106 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 3102 includes one or more processing units (CPU) 3106, which may comprise a microprocessor. The computer system 3102 further includes a physical memory 3110, such as random-access memory (RAM) for temporary storage of information, a read only memory (ROM) for permanent storage of information, and a mass storage device 3104, such as a backing store, hard drive, rotating magnetic disks, solid state disks (SSD), flash memory, phase-change memory (PCM), 3D)(Point memory, diskette, or optical media storage device. Alternatively, the mass storage device may be implemented in an array of servers. Typically, the components of the computer system 3102 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 3102 includes one or more input/output (I/O) devices and interfaces 3112, such as a keyboard, mouse, touch pad, and printer. The I/O devices and interfaces 3112 can include one or more display devices, such as a monitor, that allows the visual presentation of data to a user. More particularly, a display device provides for the presentation of GUIs as application software data, and multi-media presentations, for example. The I/O devices and interfaces 3112 can also provide a communications interface to various external devices. The computer system 3102 may comprise one or more multi-media devices 3108, such as speakers, video cards, graphics accelerators, and microphones, for example.

The computer system 3102 may run on a variety of computing devices, such as a server, a Windows server, a Structure Query Language server, a Unix Server, a personal computer, a laptop computer, and so forth. In other embodiments, the computer system 3102 may run on a cluster computer system, a mainframe computer system and/or other computing system suitable for controlling and/or communicating with large databases, performing high volume transaction processing, and generating reports from large databases. The computing system 3102 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computer system 3102 illustrated in FIG. 3 is coupled to a network 3118, such as a LAN, WAN, or the Internet via a communication link 3116 (wired, wireless, or a combination thereof). Network 3118 communicates with various computing devices and/or other electronic devices. Network 3118 is communicating with one or more computing systems 3120 and one or more data sources 3122. The module 3114 may access or may be accessed by computing systems 3120 and/or data sources 3122 through a web-enabled user access point. Connections may be a direct physical connection, a virtual connection, and other connection type. The web-enabled user access point may comprise a browser module that uses text, graphics, audio, video, and other media to present data and to allow interaction with data via the network 3118.

Access to the module 3114 of the computer system 3102 by computing systems 3120 and/or by data sources 3122 may be through a web-enabled user access point such as the computing systems' 3120 or data source's 3122 personal computer, cellular phone, smartphone, laptop, tablet computer, e-reader device, audio player, or another device capable of connecting to the network 3118. Such a device may have a browser module that is implemented as a module that uses text, graphics, audio, video, and other media to present data and to allow interaction with data via the network 3118.

The output module may be implemented as a combination of an all-points addressable display such as a cathode ray tube (CRT), a liquid crystal display (LCD), a plasma display, or other types and/or combinations of displays. The output module may be implemented to communicate with input devices 3112 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 3102 may comprise a physical or logical connection established between a remote microprocessor and a mainframe host computer for the express purpose of uploading, downloading, or viewing interactive data and databases on-line in real time. The remote microprocessor may be operated by an entity operating the computer system 3102, including the client server systems or the main server system, an/or may be operated by one or more of the data sources 3122 and/or one or more of the computing systems 3120. In some embodiments, terminal emulation software may be used on the microprocessor for participating in the micro-mainframe link.

In some embodiments, computing systems 3120 who are internal to an entity operating the computer system 3102 may access the module 3114 internally as an application or process run by the CPU 3106.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 3102 may include one or more internal and/or external data sources (for example, data sources 3122). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Cache), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MongoDB Atlas, Amazon Aurora, Amazon DynamoDB, Amazon Redshift, Amazon ElastiCache, Amazon MemoryDB for Redis, Amazon DocumentDB, Amazon Keyspaces, Amazon Neptune, Amazon Timestream, or Amazon QLDB), a non-relational database, or a record-based database.

The computer system 3102 may also access one or more databases 3122. The databases 3122 may be stored in a database or data repository. The computer system 3102 may access the one or more databases 3122 through a network 3118 or may directly access the database or data repository through I/O devices and interfaces 3112. The data repository storing the one or more databases 3122 may reside within the computer system 3102.

FIG. 5B is a block diagram illustrating a computer system 500B, according to certain embodiments. In some embodiments, the computer system 500B is one or more of user device 120, administrative device 122, prequalification system 110, data source system 114, predictive system 130, server machine 170, server machine 180, predictive server 132, etc.

In some embodiments, computer system 500B is connected (e.g., via a network, such as a Local Area Network (LAN), an intranet, an extranet, or the Internet) to other computer systems. In some embodiments, computer system 500B operates in the capacity of a server or a client computer in a client-server environment, or as a peer computer in a peer-to-peer or distributed network environment. In some embodiments, computer system 500B is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500B includes a processing device 502, a volatile memory 504 (e.g., Random Access Memory (RAM)), a non-volatile memory 506 (e.g., Read-Only Memory (ROM) or Electrically-Erasable Programmable ROM (EEPROM)), and a data storage device 516, which communicate with each other via a bus 508.

In some embodiments, processing device 502 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 500B further includes a network interface device 522 (e.g., coupled to network 574). In some embodiments, computer system 500B also includes a video display unit 510 (e.g., an LCD), an alphanumeric input device 512 (e.g., a keyboard), a cursor control device 514 (e.g., a mouse), and a signal generation device 520.

In some implementations, data storage device 516 includes a non-transitory computer-readable storage medium 524 on which store instructions 526 encoding any one or more of the methods or functions described herein, including instructions for implementing methods described herein.

In some embodiments, instructions 526 also reside, completely or partially, within volatile memory 504 and/or within processing device 502 during execution thereof by computer system 500B, hence, in some embodiments, volatile memory 504 and processing device 502 also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

In some embodiments, the methods, components, and features described herein are implemented by discrete hardware components or are integrated in the functionality of other hardware components such as ASICs, FPGAs, DSPs, or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “identifying,” “determining,” “causing,” “providing,” “receiving,” “training,” “prepopulating,” “transmitting,” “authorizing,” “dynamically authorizing,” “retrieving,” “automatically retrieving,” “creating,” “automatically creating,” “displaying,” “selecting,” “authenticating,” “extracting,” “verifying,” “generating,” “obtaining,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein or includes a general-purpose computer system selectively programmed by a computer program stored in the computer system. Such a computer program is stored in a computer-readable tangible storage medium.

Some of the methods and illustrative examples described herein are not inherently related to any particular computer or other apparatus. In some embodiments, various general-purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
identifying property data associated with a plurality of properties;
identifying user data associated with one or more users;
determining, based on the property data and the user data, that the one or more users are prequalified for a subset of the plurality of properties; and
causing a graphical representation of the subset of the plurality of properties to be displayed via a user device to the one or more users.

2. The method of claim 1, wherein the property data comprises one or more of property location data, property size data, property amenity data, property building type data, or property image data captured by an imaging device.

3. The method of claim 1, wherein:
the user data comprises one or more of financial data, employer data, historical rental data, current rental data, or payment history data; and
the identifying of the user data comprises retrieving, via an application programming interface (API), the user data from one or more sources.

4. The method of claim 1, wherein the determining that the one or more users are prequalified for a subset of the plurality of properties comprises:
providing at least one of the user data or property data as data input to a trained machine learning model;
receiving output from the trained machine learning model, the output being associated with predictive data; and
determining, based on the predictive data, that renter score data associated with the one or more users meets threshold renter score data of each of the subset of the plurality of properties.

5. The method of claim 4 further comprising:
identifying at least one of historical property data associated with historical properties or historical user data associated with historical users;
identifying historical score data comprising at least one of historical renter score data of the historical users or historical threshold renter score data of the historical properties; and
training a machine learning model using data input comprising the historical user data and target output comprising the historical score data to generate the trained machine learning model.

6. The method of claim 1, wherein the one or more users comprise one or more of:
a user;
a group of users; or
the user and a guarantor, wherein the user data further comprises: guarantor data associated with a relationship between the user and the guarantor; and percentage of rent responsible by the guarantor.

7. The method of claim 1, wherein the causing of the graphical representation of the subset of the plurality of properties to be displayed comprises causing display of a virtual reality tour of each of the subset of the plurality of properties.

8. The method of claim 1, wherein the causing of the graphical representation of the subset of the plurality of properties to be displayed comprises causing display of interaction data of a property of the subset of the plurality of properties, the interaction data comprising one or more of:
quantity of users looking at the property;
quantity of applications submitted for the property;
quantity of favorites associated with the property;
quantity of unique property listing reviews of the property; or
reviews of the property, owner, or landlord.

9. The method of claim 1 further comprising determining a first rent amount of a first property of the plurality of properties by comparing first property data of the first property to corresponding property data of one or more properties of the plurality of properties, wherein the causing of the graphical representation of the subset of the plurality of properties to be displayed comprises causing display of the first rent amount of the first property.

10. The method of claim 1 further comprising:
receiving user input selecting a property of the subset of the plurality of properties;
prepopulating, based on at least a portion of the user data of the one or more users, a digital application; and
transmitting the digital application to an administrative device for approval of the digital application.

11. The method of claim 1 further comprising:
receiving user input selecting a property of the subset of the plurality of properties; and
dynamically authorizing the one or more users to rent the property without an application.

12. The method of claim 1 further comprising:
automatically retrieving payment from a financial account of the one or more users; and
automatically creating an executed digital lease and renting the property to the one or more users without transmitting the user data to an administrator device associated with the property.

13. The method of claim 1, wherein the causing of the graphical representation of the subset of the plurality of properties to be displayed comprises causing display of a rent amount and a bid option associated with a first property of the subset, wherein the method further comprises:
displaying one or more of: a quantity of bids associated with the first property and a current bid amount; or a range of current bids;
receiving, from the user device, bid data associated with the bid option;
responsive to the bid data meeting the rent amount or a predetermined amount of time passing after the receiving of the bid data, selecting the bid data; and
transmitting, to the user device, acceptance data.

14. The method of claim 1 further comprising, responsive to determining that the user device is within a predetermined distance of a digital lock device associated with a property, causing the digital lock device to unlock.

15. The method of claim 14, wherein the digital lock device is associated with access to one or more of the property, an amenity, or a door, the method further comprising determining that the access is to be accessible by the user device based on rent level associated with the user device.

16. The method of claim 1 further comprising:
receiving a transfer request to transfer a property from a first user to a second user; and
responsive to determining that a second renter score of the second user meets a threshold renter score for the property, causing the property to be transferred from the first user to the second user.

17. The method of claim 1 further comprising:
receiving image data associated with a property of the plurality of properties; and
dynamically determine, based on the image data, at least one of a rent amount for the property or a threshold renter score for the property.

18. The method of claim 1 further comprising:
authenticating, via a secondary account of the user, a user to enter a primary account associated with the plurality of properties;
extracting user information associated with the user from the secondary account; and
verifying, based on the user information extracted from the secondary account, at least a portion of the user data entered by the user.

19. A non-transitory machine-readable storage medium storing instructions which, when executed cause a processing device to perform operations comprising:
identifying property data associated with a plurality of properties;
identifying user data associated with one or more users;
determining, based on the property data and the user data, that the one or more users are prequalified for a subset of the plurality of properties; and
causing a graphical representation of the subset of the plurality of properties to be displayed via a user device to the one or more users.

20. A system comprising:
memory; and
a processing device coupled to the memory, wherein the processing device is to:
identify property data associated with a plurality of properties;
identify user data associated with one or more users;
determine, based on the property data and the user data, that the one or more users are prequalified for a subset of the plurality of properties; and
cause a graphical representation of the subset of the plurality of properties to be displayed via a user device to the one or more users.
